(19) United States
(12) Patent Application Publication
(10) Pub. No.: US 2010/0197554 A1
(43) Pub. Date: Aug. 5, 2010

(54) LIQUID HAND DISHWASHING DETERGENT COMPOSITION

(76) Inventors: Bahar Koyuncu, Strombeek-Bever (BE); Robby Renilde François Keuleers, Lippelo (BE); Tania Patricia Maddox, Overijse (BE); Jean-Luc Philippe Bettiol, Brussel (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/698,171

(22) Filed: Feb. 2, 2010

(30) Foreign Application Priority Data
Feb. 2, 2009 (EP) 09151891.0

(51) Int. Cl. C11D 17/08

(52) U.S. Cl. 510/236

(57) ABSTRACT

A liquid hand dishwashing detergent composition comprising a protease and a humectant, a method of cleaning dishes with a liquid hand dishwashing detergent composition comprising a protease and a humectant, and a method of providing skin hydration and/or moisturization in the context of a manual dishwashing operation, using liquid hand dishwashing detergent composition comprising a protease and a humectant.

### FIELD OF INVENTION

The present invention relates to a liquid hand dishwashing detergent composition comprising a protease and a humectant, a method of cleaning dishware using said liquid hand dishwashing detergent, and a method of moisturizing skin, in the context of a manual dishwashing operation with said liquid hand dishwashing detergent.

### BACKGROUND OF THE INVENTION

During the manual dishwashing process the hands of users are exposed to light-duty liquid dishwashing detergents containing surfactants and other components which cause a loss of skin hydration and/or cause skin irritation. Consequently, many users experience skin irritation and dryness following the washing-up process, and often users feel the need to apply a soothing or moisturizing product in order to restore moisturization.

One approach has been to formulate detergent compositions comprising surfactants which are milder on skin. Incorporation of skin protecting ingredients into light duty liquid detergents is also known in the art, for example WO 99/24535, WO 97/44423 and JP 2005-179438. Other approaches have involved incorporation of active ingredients with a beneficial effect on skin sensation into detergent compositions, i.e. WO 07/028,571. The level of many of these active ingredients in the formulation is often directly correlated with the skin care benefit delivered. However, the incorporation of active ingredients is often subject to restrictions, for example due to cost limitation, regulatory and product safety restrictions and/or due to an undesirable impact on the general characteristics of the finished product.

Incorporation of an enzyme, such as a protease, or a humectant into a hand dish washing detergent composition is known to give skin care benefits. The skin care benefits induced by both proteases and humectants are directly linked to their active levels in the formulation. However, the levels of both protease and humectant in formulations are subject to restriction. The amount of humectant present impacts the general characteristics of the finished product such as the product's odour and viscosity, such that its use at certain levels is undesirable. Furthermore, the humectant level in formulations is subject to cost restrictions. The level of protease in a dish wash detergent formulation is also restricted due to product safety and regulatory labeling regulations. Furthermore, when formulating compositions containing protease as an active ingredient, consideration must be taken for the fact that protease degrades over time. Due to such restrictions, the level of protease and humectant required in order to deliver the desired skin care benefit, cannot be incorporated into liquid hand dish washing compositions.

There is therefore an unmet need for a manual hand dish detergent formulated to contain enough skin care actives to impart mildness upon the formulation, such that the skin is optimally hydrated and/or conditioned during the manual dishwashing operation, whilst also meeting product safety, regulatory, cost and general formulation restrictions.

It has been surprisingly found that use of the liquid hand dishwashing composition of the present invention results in highly efficient hydration and moisturization of the skin, more particularly the hands, while preventing negative effects of exposure of skin to dish washing detergents, e.g. skin irritation and dryness. The selection of levels of humectant and protease of the composition described herein surprisingly gives an improvement in skin moisture levels, in the context of a manual dishwashing operation, whilst also complying with the regulatory, product safety, cost and general formulation restrictions.

A further advantage of the present invention is that the co-formulation of humectant with protease results in chemical stabilization of proteases, such that the shelf life of active proteases is extended.

A further advantage of the present invention is that a positive skin care benefit, more specifically a positive skin feel benefit, even more specifically skin hydration and/or moisturization is achieved even under the dilute conditions associated with manual dish washing, and without a compromise in grease cleaning performance or suds profile of the liquid hand dishwashing detergent composition. A further advantage of the present invention is that the balance of protease and humectant of the composition of the present invention gives a skin hydration and/or skin moisturization level which is improved beyond baseline levels.

### SUMMARY OF THE INVENTION

In a first embodiment, the present invention relates to a liquid hand dishwashing detergent composition comprising at least one protease and at least one humectant. In a second embodiment the present invention relates to a method of cleaning dishware with a liquid hand dishwashing detergent composition comprising at least one protease and at least one humectant. In a third embodiment the present invention relates to a method of delivering a skin hydration and/or moisturization benefit, more specifically to the hands, during the process of cleaning dishware by use of a liquid hand dishwashing detergent composition comprising at least one protease and at least one humectant.

### DETAILED DESCRIPTION OF THE INVENTION

As used herein “grease” means materials comprising at least in part (i.e. at least 0.5% by weight of the grease) saturated and unsaturated fats and oils, preferably oils and fats derived from animal sources such as beef and/or chicken.

As used herein “hydration” means optimization of the water level in the skin through importing water from outside into the skin. As used herein “moisturization” means optimization of the water level in the skin through hydration and/or through improving the skin barrier to minimize evaporation of water from the skin.

As used herein “dishware” means a surface such as dishes, glasses, pots, pans, baking dishes and flatware made from ceramic, china, metal, glass, plastic (polyethylene, polypropylene, polystyrene, etc.) and wood.

As used herein “liquid hand dishwashing detergent composition” refers to those compositions that are employed in manual (i.e. hand) dishwashing. Such compositions are generally high sudsing or foaming in nature.

As used herein “humectant” refers to a hygroscopic substance other than water that imports hydrated water bound to the humectant through hydrogen bonding, into the skin. It is often a molecule with several hydrophilic groups, most often hydroxyl groups, but amines and carboxyl groups, sometimes esterified, can also be encountered. Humectants are generally found in many cosmetic products where moisturization is desired, including treatments such as moisturizing hair conditioners.

As used herein “cleaning” means applying to a surface for the purpose of cleaning, and/or disinfecting.

As used herein “suds profile” means the amount of sudsing (high or low) and the persistence of sudsing (sustained sudsing) throughout the washing process resulting from the use of the liquid detergent composition of the present composition. As used herein “high sudsing” refers to liquid hand dishwashing detergent compositions which are both high sudsing (i.e. a level of sudsing considered acceptable to the consumer) and have sustained sudsing (i.e. a high level of sudsing maintained throughout the dishwashing operation). This is particularly important with respect to liquid dishwashing detergent compositions as the consumer uses high sudsing as an indicator of the performance of the detergent composition. Moreover, the consumer of a liquid dishwashing detergent composition also uses the sudsing profile as an indicator that the wash solution still contains active detergent ingredients. The consumer usually renews the wash solution when the sudsing subsides. Thus, a low sudsing liquid dishwashing detergent composition formulation will tend to be replaced by the consumer more frequently than is necessary because of the low sudsing level. As used herein, “high sudsing” means a liquid has a sudsing profile before soil addition of at least about 2 cm, preferably at least about 4 cm, and more preferably about 5 cm, as measured using the Sudsing Test Method described herein, and said liquid maintains a suds height of greater than 0.5 cm for at least 2 soil additions, more preferably at least 5 soil additions, even more preferably at least 8 soil additions, as measured using the Sudsing Test Method described herein.

### The Liquid Composition

The composition according to the present invention is formulated as light-duty liquid hand dishwashing detergent composition comprising at least one protease and at least one humectant.

The liquid hand dishwashing compositions herein further contain from 30% to 95%, preferably from 40% to 80%, more preferably from 50% to 75% of the compositions herein of an aqueous liquid carrier in which the other essential and optional compositions components are dissolved, dispersed or suspended.

One preferred component of the aqueous liquid carrier is water. The aqueous liquid carrier, however, may contain other materials which are liquid, or which dissolve in the liquid carrier, at room temperature (20° C.-25° C.) and which may also serve some other function besides that of an inert filler. Such materials can include, for example, hydrotropes and solvents, discussed in more detail below. Dependent on the geography of use of the liquid detergent composition of the present invention, the water in the aqueous liquid carrier can have a hardness level of about 0-30 gpg (“gpg” is a measure of water hardness that is well known to those skilled in the art, and it stands for “grains per gallon”), preferably from 2-20 gpg.

### pH of the Composition

The liquid hand dishwashing compositions herein may have any suitable pH. Preferably the pH of the composition is adjusted to between 3 and 14. More preferably the composition has pH of between 6 and 13, most preferably between 6 and 10. The pH of the composition can be adjusted using pH modifying ingredients known in the art.

### Thickness of the Composition

The liquid hand dishwashing compositions herein are preferably thickened and have preferably a viscosity from 50 to 2000 centipoises (50-2000 mPa*s), more preferably from 100 to 1500 centipoises (100-1500 mPa*s), and most preferably from 500 to 1300 centipoises (500-900 mPa*s) at 20 s−1 and 20° C. Viscosity can be determined by conventional methods. Viscosity according to the present invention is measured using an AR 550 rheometer from TA instruments using a plate steel spindle at 40 mm diameter and a gap size of 500 μm. The high shear viscosity at 20 s−1 and low shear viscosity at 0.05 s−1 can be obtained from a logarithmic shear rate sweep from 0.1 s−1 to 25 s−1 in 3 minutes time at 20 C. The preferred rheology described therein may be achieved using internal existing structuring with detergent ingredients or by employing an external rheology modifier.

### The Humectant—Protease System

Without wishing to be bound by theory it is believed that the protease of the present invention functions to improve skin condition by removing flakes of dead (dry) skin from the outer (upper) skin layers. It is known to those skilled in the art that the level of skin moisture increases with increasing depth beneath the outer skin layer. Removal of the dry upper skin layer, e.g. by exfoliation, therefore reveals a relatively more moisturized skin surface. In addition, it is believed that proteolytic enzymes significantly improve the appearance of skin, for example skin smoothness, texture, and depth and number of lines, and skin feel:

Without being bound by theory, it is believed that humectants aid skin moisturization due to their ability to attract water and deliver this to the skin. Thus the protease and the humectant of the present invention function to improve skin hydration/moisture levels through different, and additive mechanisms. Furthermore, it is believed that certain humectants, including the low molecular weight polyols, such as glycerol, sorbitol and mannitol stabilize enzymes by repressing microbial grown, due to a reduction in water activity, and by formation of protective shells which prevent protein unfolding. Hence, formulation of liquid hand dishwashing detergent composition comprising a combination of humectant and protease, gives not only an additive effect on skin benefit, but also promotes longevity of the protease activity in the formulation.

A further advantage of this invention is that the skin care benefit can be delivered under the conditions typically found using the various different methods of washing dishes used by consumers, i.e. from neat application to dilute conditions. The liquid hand dishwashing detergent composition of the present invention can be used to provide a method of hydrating and/or moisturizing skin in the context of a manual dish washing operation.

### Enzymes

The composition of the present invention comprises an enzyme, preferably a protease. It has been found that such a composition comprising a protease will provide additional hand mildness benefit.

Suitable proteases include those of animal, vegetable or microbial origin. Microbial origin is preferred. Chemically or genetically modified mutants are included. The protease may be a serine protease, preferably an alkaline microbial protease or a trypsin-like protease. Examples of neutral or alkaline proteases include:

(a) subtilisins (EC 3.4.21.62), especially those derived from Bacillus, such as Bacillus lentus, B. alkalophilus, B. subtilis, B. amyloliquefaciens, Bacillus licheniformis, Bacillus pumilus and Bacillus gibsonii, and Cellumonas described in U.S. Pat. No. 6,312,936 B1, U.S. Pat. No. 5,679,630, U.S. Pat. No. 4,760,025, U.S. Pat. No. 5,030,378, WO 05/052146, DEA6022216A1 and DEA 6022224A1.

(b) trypsin-like proteases are trypsin (e.g., of porcine or bovine origin) and the Fusarium protease described in WO 89/06270.

(c) metalloproteases, especially those derived from Bacillus amyloliquefaciens described in WO 07/044,993A2.

Preferred proteases for use herein include polypeptides demonstrating at least 90%, preferably at least 95%, more preferably at least 98%, even more preferably at least 99% and especially 100% identity with the wild-type enzyme from Bacillus lentus or the wild-type enzyme from Bacillus Amyloliquefaciens, comprising mutations in one or more of the following positions, using the BPN' numbering system and amino acid abbreviations as illustrated in WO00/37627, which is incorporated herein by reference: 3, 4, 68, 76, 87, 99, 101, 103, 104, 118, 128, 129, 130, 159, 160, 167, 170, 194, 199, 205, 217, 222, 232, 236, 245, 248, 252, 256 & 259.

More preferred proteases are those derived from the BPN' and Carlsberg families, especially the subtilisin BPN' protease derived from Bacillus amyloliquefaciens. In one embodiment the protease is that derived from Bacillus amyloliquefaciens, comprising the Y217L mutation whose sequence is shown below in standard 1-letter amino acid nomenclature, as described in EP342177B1 (sequence given on p. 4-5).

AQSVPYGVSQIKAPALHSQGYTGSNVKVAVIDSGIDSSHPDLKVAGGASM
VPSETNPFQD
NNSHGTHVAGTVAALNNSIGVLGVAPSASLYAVKVLGADGSGQYSWIING
IEWAIANNMD
VINMSLGGPSGSAALKAAVDKAVASGVVVVAAAGNEGTSGSSSTVGYPGK
YPSVIAVGAV
DSSNQRASFSSVGPELDVMAPGVSIQSTLPGNKYGALNGTSMASPHVAGA
AALILSKHPN
WTNTQVRSSLENTTTKLGDSFYYGKGLINVQAAAQ

Preferred commercially available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novozymes A/S (Denmark), those sold under the tradename Maxatase®, Maxacal®, Maxapem®, Properase®, Purafect®, Purafect Prime®, Purafect Ox®, FN3®, FN4®, Excellase® and Purafect OXP® by Genencor International, and those sold under the tradename Opticlean® and Optimase® by Solvay Enzymes. In one aspect, the preferred protease is a subtilisin BPN' protease derived from Bacillus amyloliquefaciens, preferably comprising the Y217L mutation, sold under the tradename Purafect Prime®, supplied by Genencor International.

Enzymes may be incorporated into the compositions in accordance with the invention at a level of from 0.00001% to 1% of enzyme protein by weight of the total composition, preferably at a level of from 0.0001% to 0.5% of enzyme protein by weight of the total composition, more preferably at a level of from 0.0001% to 0.1% of enzyme protein by weight of the total composition.

The aforementioned enzymes can be provided in the form of a stabilized liquid or as a protected liquid or encapsulated enzyme. Liquid enzyme preparations may, for instance, be stabilized by adding a polyol such as propylene glycol, a sugar or sugar alcohol, lactic acid or boric acid or a protease stabilizer such as 4-formyl phenyl boronic acid according to established methods. Protected liquid enzymes or encapsulated enzymes may be prepared according to the methods disclosed in U.S. Pat. No. 4,906,396, U.S. Pat. No. 6,221,829 B1, U.S. Pat. No. 6,359,031 B1 and U.S. Pat. No. 6,242,405 B1.

### The Humectant

The composition of the present invention comprises at least one humectant at a level of from 0.1 wt % to 50 wt %, preferably from 1 wt % to 20 wt %, more preferably from 1% to 10% by weight of the composition, even more preferably from 1% to 6% and most preferably from 2% to 5% by weight of the total composition.

Humectants that can be used according to this invention include those substances that exhibit an affinity for water and help enhance the absorption of water onto a substrate, preferably skin. Specific non-limiting examples of particularly suitable humectants include glycerol, diglycerol, polyethyleneglycol (PEG-4), propylene glycol, hexylene glycol, butylene glycol, (di)-propylene glycol, glyceryl triacetate, polyalkyleneglycols, phospholipids, collagen, elastin, ceramides, lecithin, and mixtures thereof. Others can be polyethylene glycol ether of methyl glucose, pyrrolidone carboxylic acid (PCA) and its salts, pidolic acid and salts such as sodium pidolate, polyols like sorbitol, xylitol and maltitol, or polymeric polyols like polydextrose or natural extracts like quillaia, or lactic acid or urea. Also included are alkyl polyglycosides, polybetaine polysiloxanes, and mixtures thereof. Lithium chloride is an excellent humectant but is toxic. Additional suitable humectants are polymeric humectants of the family of water soluble and/or swellable/and/or with water gelatin polysaccharides such as hyaluronic acid, chitosan and/or a fructose rich polysaccharide which is e.g. available as Fucogel® 1000 (CAS-Nr 178463-23-5) by SOLABIA S.

Humectants containing oxygen atoms are preferred over those containing nitrogen or sulphur atoms. More preferred humectants are polyols or are carboxyl containing such as glycerol, diglycerol, sorbitol, Propylene glycol, Polyethylene Glycol, Butylene glycol; and/or pidolic acid and salts thereof, and most preferred are humectants selected from the group consisting of glycerol (sourced from Procter & Gamble chemicals), sorbitol, sodium lactate, and urea, or mixtures thereof.

### Surfactant System

In a preferred embodiment, the composition of the present invention will comprise 4% to 40%, preferably 6% to 32%, more preferably 11% to 25% weight of the total composition of an anionic surfactant with no more than 15%, preferably no more than 10%, more preferably no more than 5% by weight of the total composition, of a sulfonate surfactant. It has been found that such surfactant system will provide the excellent cleaning required from a hand dishwashing liquid composition while being very soft and gentle to the hands. Furthermore, it has been surprisingly found that the combination of the surfactant system of the present invention with a humectant and/or a protease does provide the expected superior level of grease cleaning while providing as well superior hand feel and mildness to the hands, such as superior moisturisation.

Suitable anionic surfactants to be used in the compositions and methods of the present invention are sulfate, sulfosuccinates, sulfonate, and/or sulfoacetate; preferably alkyl sulfate and/or alkyl ethoxy sulfates; more preferably a combination of alkyl sulfates and/or alkyl ethoxy sulfates with a combined ethoxylation degree less than 5, preferably less than 3, more preferably less than 2.

### Sulphate Surfactants

Suitable sulphate surfactants for use in the compositions herein include water-soluble salts or acids of C₁₀-C₁₄ alkyl or hydroxyalkyl, sulphate and/or ether sulfate. Suitable counterions include hydrogen, alkali metal cation or ammonium or substituted ammonium, but preferably sodium.

Where the hydrocarbyl chain is branched, it preferably comprises C₁₋₄ alkyl branching units. The average percentage branching of the sulphate surfactant is preferably greater than 30%, more preferably from 35% to 80% and most preferably from 40% to 60% of the total hydrocarbyl chains.

The sulphate surfactants may be selected from C₈-C₂₀ primary, branched-chain and random alkyl sulphates (AS); C₁₀-C₁₈ secondary (2,3) alkyl sulphates; C₁₀-C₁₈ alkyl alkoxy sulphates (AEₓS) wherein preferably x is from 1-30; C₁₀-C₁₈ alkyl alkoxy carboxylates preferably comprising 1-5 ethoxy units; mid-chain branched alkyl sulphates as discussed in U.S. Pat. No. 6,020,303 and U.S. Pat. No. 6,060,443; mid-chain branched alkyl alkoxy sulphates as discussed in U.S. Pat. No. 6,008,181 and U.S. Pat. No. 6,020,303.

### Alkyl Sulfosuccinates—Sulfoacetate

Other suitable anionic surfactants are alkyl, preferably dialkyl, sulfosuccinates and/or sulfoacetate. The dialkyl sulfosuccinates may be a C₆₋₁₅ linear or branched dialkyl sulfosuccinate. The alkyl moieties may be symmetrical (i.e., the same alkyl moieties) or asymmetrical (i.e., different alkyl moiety.es). Preferably, the alkyl moiety is symmetrical.

### Sulphonate Surfactants

The compositions of the present invention will preferably comprise no more than 15% by weight, preferably no more than 10%, even more preferably no more than 5% by weight of the total composition, of a sulphonate surfactant. Those include water-soluble salts or acids of C₁₀-C₁₄ alkyl or hydroxyalkyl, sulphonates; C₁₁-C₁₈ alkyl benzene sulphonates (LAS), modified alkylbenzene sulphonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also include the alkyl glyceryl sulphonate surfactants.

Further Surfactant

The compositions can comprise further a surfactant selected from nonionic, cationic, amphoteric, zwitterionic, semi-polar nonionic surfactants, and mixtures thereof. In a further preferred embodiment, the composition of the present invention will further comprise amphoteric and/or zwitterionic surfactant, more preferably an amine oxide or betaine surfactant.

The most preferred surfactant system for the compositions of the present invention will therefore comprise: (i) 4% to 40%, preferably 6% to 32%, more preferably 11% to 25% weight of the total composition of an anionic surfactant with no more than 15%, preferably no more than 10%, more preferably no more than 5% by weight of the total composition, of a sulfonate surfactant; (2) combined with 0.01% to 20% wt, preferably from 0.2% to 15% wt, more preferably from 0.5% to 10% by weight of the liquid detergent composition amphoteric and/or zwitterionic surfactant, more preferably an amphoteric and even more preferred an amine oxide surfactant

The total level of surfactants is usually from 1.0% to 50% wt, preferably from 5% to 40% wt, more preferably from 8% to 35% by weight of the liquid detergent composition. Non-limiting examples of optional surfactants are discussed below.

### Amphoteric and Zwitterionic Surfactants

The amphoteric and zwitterionic surfactant can be comprised at a level of from 0.01% to 20%, preferably from 0.2% to 15%, more preferably 0.5% to 10% by weight of the liquid detergent composition. Suitable amphoteric and zwitterionic surfactants are amine oxides and betaines.

Most preferred are amine oxides, especially coco dimethyl amine oxide or coco amido propyl dimethyl amine oxide. Amine oxide may have a linear or mid-branched alkyl moiety. Typical linear amine oxides include water-soluble amine oxides containing one R1 C₈₋₁₈ alkyl moiety and 2 R2 and R3 moieties selected from the group consisting of C₁₋₃ alkyl groups and C₁₋₃ hydroxyalkyl groups. Preferably amine oxide is characterized by the formula R1−N(R2)(R3) O wherein R₁ is a C₈₋₁₈ alkyl and R₂ and R₃ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n₁ carbon atoms with one alkyl branch on the alkyl moiety having n₂ carbon atoms. The alkyl branch is located on the a carbon from the nitrogen on the alkyl moiety. This type of branching for the amine oxide is also known in the art as an internal amine oxide. The total sum of n₁ and n₂ is from 10 to 24 carbon atoms, preferably from 12 to 20, and more preferably from 10 to 16. The number of carbon atoms for the one alkyl moiety (n₁) should be approximately the same number of carbon atoms as the one alkyl branch (n₂) such that the one alkyl moiety and the one alkyl branch are symmetric. As used herein “symmetric” means that |n₁−n₂| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C₁₋₃ alkyl, a C₁₋₃ hydroxyalkyl group, or a polyethylene oxide group containing an average of from about 1 to about 3 ethylene oxide groups. Preferably the two moieties are selected from a C₁₋₃ alkyl, more preferably both are selected as a C₁ alkyl.

Other suitable surfactants include betaines such alkyl betaines, alkylamidobetaine, amidazoliniumbetaine, sulfobetaine (INCI Sultaines) as well as the Phosphobetaine and preferably meets formula I:

R¹—[CO—X(CH₂)ₙ]ₓ—N⁺(R²)(R₃)—(CH₂)ₘ—[CH(OH)—CH₂]_{y}—Y— (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R¹1 as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropyl betaines (Cocoamidopropylbetain).

### Nonionic Surfactants

Nonionic surfactant, when present, is comprised in a typical amount of from 0.1% to 20%, preferably 0.5% to 10% by weight of the liquid detergent composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol.

Also suitable are alkylpolyglycosides having the formula R²O(CₙH₂ₙO)ₜ(glycosyl)ₓ (formula (III)), wherein R² of formula (III) is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n of formula (III) is 2 or 3, preferably 2; t of formula (III) is from 0 to 10, preferably 0; and x of formula (III) is from 1.3 to 10, preferably from 1.3 to 3, most preferably from 1.3 to 2.7. The glycosyl is preferably derived from glucose. Also suitable are alkylglycerol ethers and sorbitan esters.

Also suitable are fatty acid amide surfactants having the formula (IV):

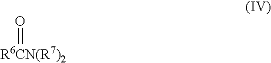

wherein R⁶ of formula (IV) is an alkyl group containing from 7 to 21, preferably from 9 to 17, carbon atoms and each R⁷ of formula (IV) is selected from the group consisting of hydrogen, C₁-C₄ alkyl, C₁-C₄ hydroxyalkyl, and —(C₂H₄O)ₓH where x of formula (IV) varies from 1 to 3. Preferred amides are C₈-C₂₀ ammonia amides, monoethanolamides, diethanolamides, and isopropanolamides.

### Cationic Surfactants

Cationic surfactants, when present in the composition, are present in an effective amount, more preferably from 0.1% to 20%, by weight of the liquid detergent composition. Suitable cationic surfactants are quaternary ammonium surfactants. Suitable quaternary ammonium surfactants are selected from the group consisting of mono C₆-C₁₆, preferably C₆-C₁₀ N-alkyl or alkenyl ammonium surfactants, wherein the remaining N positions are substituted by methyl, hydroxyehthyl or hydroxypropyl groups. Another preferred cationic surfactant is an C₆-C₁₈ alkyl or alkenyl ester of a quaternary ammonium alcohol, such as quaternary chlorine esters. More preferably, the cationic surfactants have the formula (V):

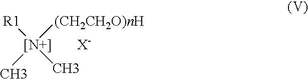

wherein R1 of formula (V) is C₈-C₁₈ hydrocarbyl and mixtures thereof, preferably, C₈₋₁₄ alkyl, more preferably, C₈, C₁₀ or C₁₂ alkyl, and X of formula (V) is an anion, preferably, chloride or bromide.

### The Cationic Polymer

The liquid hand dishwashing compositions herein optionally comprise one or more cationic polymers. When present, the cationic polymer will typically be present in the composition of the present invention at a level of from 0.001 wt % to 10 wt %, preferably from 0.01 wt % to 5 wt %, more preferably from 0.05% to 1% by weight of the composition. It has been found that such composition comprising a cationic polymer will provide additional hand mildness benefits.

Suitable cationic deposition polymers for use in current invention contain cationic nitrogen containing moieties such as quaternary ammonium or cationic protonated amino moieties. The average molecular weight of the cationic deposition polymer is between about 5000 to about 10 million, preferably at least about 100000, more preferably at least about 200000, but preferably not more than about 1.5 million. The polymers also have a cationic charge density ranging from about 0.2 meq/g to about 5 meq/g, preferably at least about 0.4 meq/g, more preferably at least about 0.6 meq/g, at the pH of intended use of the dishwashing liquid formulation. As used herein the “charge density” of the cationic polymers is defined as the number of cationic sites per polymer gram atomic weight (molecular weight). Any anionic counterions can be used in association with cationic deposition polymers.

Specific examples of the water soluble cationized polymer include cationic polysaccharides such as cationized cellulose derivatives, cationized starch and cationized guar gum derivatives. Also included are synthetically derived copolymers such as homopolymers of diallyl quaternary ammonium salts, diallyl quaternary ammonium salt/acrylamide copolymers, quaternized polyvinylpyrrolidone derivatives, polyglycol polyamine condensates, vinylimidazolium trichloride/vinylpyrrolidone copolymers, dimethyldiallylammonium chloride copolymers, vinylpyrrolidone/quaternized dimethylaminoethyl methacrylate copolymers, polyvinylpyrrolidone/alkylamino acrylate copolymers, polyvinylpyrrolidone/alkylamino acrylate/vinylcaprolactam copolymers, vinylpyrrolidone/methacrylamidopropyl trimethylammonium chloride copolymers, alkylacrylamide/acrylate/alkylaminoalkylacrylamide/polyethylene glycol methacrylate copolymers, adipic acid/dimethylaminohydroxypropyl ethylenetriamine copolymer.

Preferred cationic polymers are cationic polysaccharides, more preferably cationic cellulose polymers or cationic guar gum derivatives such as guar hydroxypropyltrimonium chloride, such as the Jaguar series ex Rhodia and N-Hance polymer series available from Aqualon, even more preferred are the salts of hydroxyethyl cellulose reacted with trimethyl ammonium substituted epoxide, referred to in the industry (CTFA) as Polyquaternium-10, such as the UCARE LR400 ex Dow Amerchol.

### Rheology Modifier

The composition herein may further comprise as an optional ingredient a rheology modifier. The overall objective in adding such a rheology modifier to the compositions herein is to arrive at liquid compositions which are suitably functional and aesthetically pleasing from the standpoint of product thickness, product pourability, product optical properties, and/or particles suspension performance. Thus the rheology modifier will generally serve to establish appropriate rheological characteristics of the liquid product and will do so without imparting any undesirable attributes to the product such as unacceptable optical properties or unwanted phase separation.

Generally the rheology modifier will comprise from 0.001% to 3% by weight, preferably from 0.01% to 1% by weight, more preferably from 0.02% to 0.8% by weight, of the total compositions herein.

The rheology modifier is selected from non-polymeric crystalline, hydroxy-functional materials, and/or polymeric rheology modifiers which impart shear thinning characteristics to the aqueous liquid matrix of the composition.

Specific examples of preferred crystalline, hydroxyl-containing rheology modifiers include castor oil and its derivatives. Especially preferred are hydrogenated castor oil derivatives such as hydrogenated castor oil and hydrogenated castor wax. Commercially available, castor oil-based, crystalline, hydroxyl-containing rheology modifiers include THIXCIN® from Rheox, Inc. (now Elementis).

Suitable polymeric rheology modifiers include those of the polyacrylate, polysaccharide or polysaccharide derivative type. Polysaccharide derivatives typically used as rheology modifiers comprise polymeric gum materials. Such gums include pectine, alginate, arabinogalactan (gum Arabic), carrageenan, gellan gum, xanthan gum and guar gum and carboxymethyl cellulose. Commercial examples of these polymeric rheology modifiers include Gellan marketed by CP Kelco U.S., Inc. under the KELCOGEL tradename, and especially preferred is Micro Fibril Cellulose (MFC) from CPKelko marketed under Cellulon® tradename.

A further alternative and suitable rheology modifier is a combination of a solvent and a polycarboxylate polymer. Preferred embodiment the rheology modifier is a polyacrylate of unsaturated mono- or di-carbonic acid and 1-30C alkyl ester of the (meth) acrylic acid. Such copolymers are available from Noveon Inc under the tradename Carbopol Aqua 30.

The Pearlescent agent

The composition herein may comprise, as an optional ingredient, one or more pearlescent agents. Suitable agents are crystalline or glassy solids, transparent or translucent compounds capable of reflecting and refracting light to produce a pearlescent effect. The composition of the present invention can comprise either an organic and/or an inorganic pearlescent agent.

When the composition of the present invention comprises an organic pearlescent agent, it is comprised at an active level of from 0.05% to 2.0% wt, preferably from 0.1% to 1.0% by weight of the total composition of the 100% active organic pearlescent agents. Suitable organic pearlescent agents include monoester and/or diester of alkylene glycols.

Typical examples are fatty monoesters and/or diesters of ethylene glycol, propylene glycol, diethylene glycol, dipropylene glycol, triethylene glycol or tetraethylene glycol. Example of fatty ester are commercially available such as PEG6000MS® is available from Stepan, Empilan EGDS/A® is available from Albright & Wilson or pre-crystallized organic pearlescent commercially available such as Stepan, Pearl-2 and Stepan Pearl 4 (produced by Stepan Company Northfield, Ill.), Mackpearl 202, Mackpearl 15-DS, Mackpearl DR-104, Mackpearl DR-106 (all produced by McIntyre Group, Chicago, Ill.), Euperlan PK900 Benz-W and Euperlan PK 3000 AM (produced by Cognis Corp).

When the composition of the present invention comprise an inorganic pearlescent agent, it is comprised at an active level of from 0.005% to 1.0% wt, preferably from 0.01% to 0.2% by weight of the composition of the 100% active inorganic pearlescent agents. Inorganic pearlescent agents include aluminosilicates and/or borosilicates. Preferred are the aluminosilicates and/or borosilicates which have been treated to have a very high refractive index, preferably silica, metal oxides, oxychloride coated aluminosilicate and/or borosilicates. More preferably inorganic pearlescent agent is mica, even more preferred titanium dioxide treated mica such as BASF Mearlin Superfine.

Other commercially available suitable inorganic pearlescent agents are available from Merck under the tradenames Iriodin, Biron, Xirona, Timiron Colorona, Dichrona, Candurin and Ronastar. Other commercially available inorganic pearlescent agent are available from BASF (Engelhard, Mearl) under tradenames Biju, Bi-Lite, Chroma-Lite, Pearl-Glo, Mearlite and from Eckart under the tradenames Prestige Soft Silver and Prestige Silk Silver Star.

Particle size (measured across the largest diameter of the sphere) of the pearlescent agent is typically below 200 microns, preferably below 100 microns, more preferably below 50 microns.

### Cleaning Polymer

The liquid hand dishwashing composition herein may optionally further comprise one or more alkoxylated polyethyleneimine polymer. The composition may comprise from 0.01 wt % to 10 wt %, preferably from 0.01 wt % to 2 wt %, more preferably from 0.1 wt % to 1.5 wt %, even more preferable from 0.2% to 1.5% by weight of the total composition of an alkoxylated polyethyleneimine polymer as described on page 2, line 33 to page 5, line 5 and exemplified in examples 1 to 4 at pages 5 to 7 of WO2007/135645 published by The Procter & Gamble Company.

The alkoxylated polyethyleneimine polymer of the present composition has a polyethyleneimine backbone having from 400 to 10000 weight average molecular weight, preferably from 400 to 7000 weight average molecular weight, alternatively from 3000 to 7000 weight average molecular weight.

These polyamines can be prepared for example, by polymerizing ethyleneimine in presence of a catalyst such as carbon dioxide, sodium bisulfite, sulfuric acid, hydrogen peroxide, hydrochloric acid, acetic acid, and the like.

The alkoxylation of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety or benzyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

The composition may further comprise the amphiphilic graft polymers based on water soluble polyalkylene oxides (A) as a graft base and sides chains formed by polymerization of a vinyl ester component (B), said polymers having an average of ≦1 graft site per 50 alkylene oxide units and mean molar mass Mw of from 3,000 to 100,000 described in BASF patent application WO2007/138053 on pages 2 line 14 to page 10, line 34 and exemplified on pages 15-18.

### Magnesium Ions

The optional presence of magnesium ions may be utilized in the detergent composition when the compositions are used in softened water that contains few divalent ions. When utilized, the magnesium ions preferably are added as a hydroxide, chloride, acetate, sulphate, formate, oxide or nitrate salt to the compositions of the present invention. When included, the magnesium ions are present at an active level of from 0.01% to 1.5%, preferably from 0.015% to 1%, more preferably from 0.025% to 0.5%, by weight of the total liquid hand dishwashing composition.

### Solvent

The present compositions may optionally comprise a solvent. Suitable solvents include C₄₋₁₄ ethers and diethers, glycols, alkoxylated glycols, C₆-C₁₆ glycol ethers, alkoxylated aromatic alcohols, aromatic alcohols, aliphatic branched alcohols, alkoxylated aliphatic branched alcohols, alkoxylated linear C₁-C₅ alcohols, linear C₁-C₅ alcohols, amines, C₈-C₁₄ alkyl and cycloalkyl hydrocarbons and halohydrocarbons, and mixtures thereof. When present, the liquid detergent composition will contain from 0.01% to 20%, preferably from 0.5% to 20%, more preferably from 1% to 10% by weight of the liquid detergent composition of a solvent. These solvents may be used in conjunction with an aqueous liquid carrier, such as water, or they may be used without any aqueous liquid carrier being present.

### Hydrotrope

The liquid detergent compositions of the invention may optionally comprise a hydrotrope in an effective amount so that the liquid detergent compositions are appropriately compatible in water. Suitable hydrotropes for use herein include anionic-type hydrotropes, particularly sodium, potassium, and ammonium xylene sulphonate, sodium, potassium and ammonium toluene sulphonate, sodium potassium and ammonium cumene sulphonate, and mixtures thereof, and related compounds, as disclosed in U.S. Pat. No. 3,915,903. The liquid detergent compositions of the present invention typically comprise from 0% to 15% by weight of the total liquid detergent composition of a hydrotropic, or mixtures thereof, preferably from 1% to 10%, most preferably from 3% to 10% by weight of the total liquid hand dishwashing composition.

### Polymeric Suds Stabilizer

The compositions of the present invention may optionally contain a polymeric suds stabilizer. These polymeric suds stabilizers provide extended suds volume and suds duration of the liquid detergent compositions. These polymeric suds stabilizers may be selected from homopolymers of (N,N-dialkylamino) alkyl esters and (N,N-dialkylamino) alkyl acrylate esters. The weight average molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulphate, or nitrate salt of (N,N-dimethylamino)alkyl acrylate ester.

One preferred polymeric suds stabilizer is (N,N-dimethylamino)alkyl acrylate esters, namely the acrylate ester represented by the formula (VII):

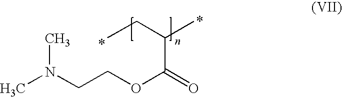

Other preferred suds boosting polymers are copolymers of hydroxypropylacrylate/dimethyl aminoethylmethacrylate (copolymer of HPA/DMAM), represented by the formulae VIII and IX

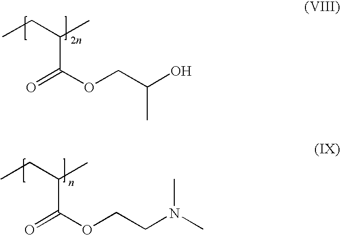

When present in the compositions, the polymeric suds booster/stabilizer may be present in the composition from 0.01% to 15%, preferably from 0.05% to 10%, more preferably from 0.1% to 5%, by weight of the liquid detergent composition.

Another preferred class of polymeric suds booster polymers are hydrophobically modified cellulosic polymers having a number average molecular weight (Mw) below 45,000; preferably between 10,000 and 40,000; more preferably between 13,000 and 25,000. The hydrophobically modified cellulosic polymers include water soluble cellulose ether derivatives, such as nonionic and cationic cellulose derivatives. Preferred cellulose derivatives include methylcellulose, hydroxypropyl methylcellulose, hydroxyethyl methylcellulose, and mixtures thereof.

### Diamines

Another optional ingredient of the compositions according to the present invention is a diamine. Since the habits and practices of the users of liquid detergent compositions show considerable variation, the composition will preferably contain 0% to 15%, preferably 0.1% to 15%, preferably 0.2% to 10%, more preferably 0.25% to 6%, more preferably 0.5% to 1.5% by weight of said composition of at least one diamine.

Preferred organic diamines are those in which pK1 and pK2 are in the range of 8.0 to 11.5, preferably in the range of 8.4 to 11, even more preferably from 8.6 to 10.75. Preferred materials include 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DYTEK EP®) (pK1=10.5; pK2=8.9), 2-methyl 1,5 pentane diamine (DYTEK A®) (pK1=11.2; pK2=10.0). Other preferred materials include primary/primary diamines with alkylene spacers ranging from C₄ to C₈. In general, it is believed that primary diamines are preferred over secondary and tertiary diamines. pKa is used herein in the same manner as is commonly known to people skilled in the art of chemistry: in an all-aqueous solution at 25° C. and for an ionic strength between 0.1 to 0.5 M. Values referenced herein can be obtained from literature, such as from “Critical Stability Constants: Volume 2, Amines” by Smith and Martel, Plenum Press, NY and London, 1975.

### Carboxylic Acid

The liquid detergent compositions according to the present invention may comprise a linear or cyclic carboxylic acid or salt thereof to improve the rinse feel of the composition. The presence of anionic surfactants, especially when present in higher amounts in the region of 15-35% by weight of the total composition, results in the composition imparting a slippery feel to the hands of the user and the dishware.

Carboxylic acids useful herein include C₁₋₆ linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms, and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2, 4 benzene tricarboxylic acid, pentanoic acid and salts thereof, citric acid and salts thereof, and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof, when present, is preferably present at the level of from 0.1% to 5%, more preferably from 0.2% to 1% and most preferably from 0.25% to 0.5% by weight of the total composition.

The liquid detergent compositions of the present invention may be packages in any suitable packaging for delivering the liquid detergent composition for use. Preferably the package is a clear package made of glass or plastic.

### Other Optional Components:

The liquid detergent compositions herein can further comprise a number of other optional ingredients suitable for use in liquid detergent compositions such as perfume, dyes, opacifiers, chelants, preservatives, disinfecting agents and pH buffering means so that the liquid detergent compositions herein generally have a pH of from 3 to 14, preferably 6 to 13, most preferably 6 to 10. The pH of the composition can be adjusted using pH modifying ingredients known in the art.

A further discussion of acceptable optional ingredients suitable for use in light-duty liquid detergent composition may be found in U.S. Pat. No. 5,798,505.

### The Process of Cleaning/Treating a Dishware

The method of dishwashing of the present invention comprises cleaning a dishware with a liquid hand dishwashing detergent composition comprising at least one protease and at least one humectant in combination. Said dishwashing operation comprises the steps of applying said composition onto said dishware, typically in diluted or neat form and rinsing said composition from said surface, or leaving said composition to dry on said surface without rinsing said surface. Instead of leaving said composition to air dry on said surface, it can also be hand-dried using a kitchen towel. During the dishwashing operation, particularly during the application of said liquid composition to the dishware and/or rinsing away of said liquid composition from the dishware, the hands and skin of the user may be exposed to the liquid composition in diluted or neat form.

By “in its neat form”, it is meant herein that said liquid composition is applied directly onto the surface to be treated without undergoing any dilution by the user (immediately) prior to the application. This direct application of that said liquid composition onto the surface to be treated can be achieved through direct squeezing of that said liquid composition out of the hand dishwashing liquid bottle onto the surface to be cleaned, or through squeezing that said liquid composition out of the hand dishwashing liquid bottle on a pre-wetted or non pre-wetted cleaning article, such as without intending to be limiting a sponge, a cloth or a brush, prior to cleaning the targeted surface with said cleaning article. By “diluted form”, it is meant herein that said liquid composition is diluted by the user with an appropriate solvent, typically with water. By “rinsing”, it is meant herein contacting the dishware cleaned with the process according to the present invention with substantial quantities of appropriate solvent, typically water, after the step of applying the liquid composition herein onto said dishware. By “substantial quantities”, it is meant usually 0.1 to 20 liters.

In one embodiment of the present invention, the composition herein can be applied in its diluted form. Soiled dishes are contacted with an effective amount, typically from 0.5 ml to 20 ml (per 25 dishes being treated), preferably from 3 ml to 10 ml, of the liquid detergent composition of the present invention diluted in water. The actual amount of liquid detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. The particular product formulation, in turn, will depend upon a number of factors, such as the intended market (i.e., U.S., Europe, Japan, etc.) for the composition product. Typical light-duty detergent compositions are described in the examples section.

Generally, from 0.01 ml to 150 ml, preferably from 3 ml to 40 ml, even more preferably from 3 ml to 10 ml of a liquid detergent composition of the invention is combined with from 2000 ml to 20000 ml, more typically from 5000 ml to 15000 ml of water in a sink having a volumetric capacity in the range of from 1000 ml to 20000 ml, more typically from 5000 ml to 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from 1 to 10 seconds, although the actual time will vary with each application and user. The contacting of cloth, sponge, or similar article to the dish surface is preferably accompanied by a concurrent scrubbing of the dish surface.

Another method of the present invention will comprise immersing the soiled dishes into a water bath or held under running water without any liquid dishwashing detergent. A device for absorbing liquid dishwashing detergent, such as a sponge, is placed directly into a separate quantity of a concentrated pre-mix of liquid dishwashing detergent in solvent, typically water, for a period of time typically ranging from 1 to 5 seconds. The absorbing device, and consequently the liquid dishwashing composition in solvent, typically water, is then contacted individually to the surface of each of the soiled dishes to remove said soiling. The absorbing device is typically contacted with each dish surface for a period of time range from 1 to 10 seconds, although the actual time of application will be dependent upon factors such as the degree of soiling of the dish. The contacting of the absorbing device to the dish surface is preferably accompanied by concurrent scrubbing. Typically, said concentrated pre-mix of diluted liquid dishwashing detergent is formed by combining 1 ml to 200 ml, more typically 5 ml to 50 ml, of neat dishwashing detergent with 50 ml to 1500 ml of water, more typically from 200 ml to 1000 ml of water.

Method of Hydrating and/or Moisturizing Skin

In another embodiment this invention relates to use of a liquid hand dishwashing detergent composition to deliver a positive skin benefit, more specifically a positive skin feel, even more specifically a hydrating/moisturizing benefit to the skin, especially the hands, during a manual dishwashing operation. This method consists of the step of contacting the skin of the person carrying out the dishwashing operation with a liquid hand dishwashing detergent composition comprising at least one protease and at least one humectant. The liquid hand dishwashing composition may be in its neat form, or in a diluted or concentrated premix form as outlined in the ‘process of cleaning/treating a dishware’ described herein.

### Sudsing Test Method.

The sudsing profile can be measured by employing a suds cylinder tester (SCT), having a set of up to 6 cylinders (reference+up to 5 test products). Each cylinder is typically 30 cm long, and 10 cm in diameter. The cylinder walls are 0.5 cm thick, and the cylinder bottom is 1 cm thick. The SCT rotates a test solution in a closed cylinder, typically a plurality of clear plastic cylinders, at a constant rate of about 21 full, vertical revolutions per minute, for 2 minutes, after which the suds height is measured. 1 ml of Eileen B. Lewis Soil (comprising 12.7% Crisco oil, 27.8% Crisco shortening, 7.6% Lard, 51.7% Refined rendered edible beef tallow, 0.14% oleic acid, 0.04% palmitic acid and 0.02% stearic acid. Supplied by J&R Coordinating Services, Ohio) is added to the test solution, agitated again, and the resulting suds height measured, again. More soiling cycles are typically added till a minimum suds height, typically 0.5 cm, is reached. The number of soiling cycles is indicative for the suds mileage performance (more soiling cycles indicates better suds mileage performance). Such a test may be used to simulate the initial sudsing profile of a composition, as well as its sudsing profile during use, as more soils are introduced from the surface being washed.

The sudsing profile test is as follows:

1. Prepare a set of clean, dry, calibrated cylinders, and water having water hardness of 30 gpg, a temperature of 40 degrees Celcius, and surfactant active concentration of 0.03% by weight.

2. Add the appropriate amount of test composition to each cylinder and add water to make a total 500 mL of composition+water in each cylinder.

3. Seal the cylinders and place them in the SCT.

4. Turn on the SCT and rotate the cylinders for 2 minutes.

5. Within 1 minute, measure the height of the suds in centimeters. If suds height still higher than 0.5 cm, add immediately after reading the suds height the soil and restart steps 4 and 5.

6. The sudsing profile is the average level of suds, in cm, generated by the composition across 2 replicates. Suds height is measured using a ruler, as the distance from the bottom of the suds to the highest point of the suds.

The “high sudsing” liquid compositions according to the invention have a sudsing profile of at least about 2 cm, preferably at least about 4 cm, and more preferably about 5 cm high, before soil addition. Soil addition cycles are stopped when suds height in each cylinder reaches 0.5 cm only. In addition, a “high sudsing” liquid composition maintains a suds height of greater than 0.5 cm for at least 2, more preferably at least 5, even more preferably at least 8 soil additions.

### EXAMPLES

TABLE A
Light-Duty Liquid Dishwashing Detergent Composition

| | Ex. 1 | Ex. 2 | Ex. 3 | Ex. 4 |
|---|---|---|---|---|
| Linear Alkylbenzene | — | | — | — |
| Sulfonate (1) | | | | |
| Alkyl Ethoxy Sulfate (2) | 20% | 15% | 18% | 20% |
| Paraffin Sulfonate (C15) | — | — | — | — |
| CAP = coco amido propyl | — | — | 7% | 5% |
| Betaine | | | | |
| Nonionic (3) | — | — | 0.5% | — |
| Amine Oxide (4) | 4% | 5% | — | 3% |
| Alkylpolyglucoside | | | | 3% |
| Alcohol (5) | — | — | 5% | 7% |
| PPG = | 1% | 0.8% | — | — |
| polypropyleneglycol | | | | |
| Citrate | — | — | 0.3% | 0.6% |
| Salt (6) | 1.2% | 1.0% | — | 0.5% |
| SCS = sodium cumene | — | — | 0.8% | — |
| sulfonate | | | | |
| glycerol | 12% | 7% | 4% | — |
| Nalactate | | | | 8% |
| cationic polymer (7) | 0.1% | 0.1% | 0.3% | 0.2% |
| Purafect Prime ® ex | 90 | 55 | 35 | 40 |
| Genencor (ppm) | | | | |
| Glycol distearate from | 0.4 | 0 | 0.4 | 0 |
| Euperlan ® Cognis | | | | |
| Hydrogenated Castor Oil | 0 | 0.1 | 0 | 0.1 |
| Thixcin ® Elementis | | | | |
| Mica (BASF Mearlin | 0 | 0.05 | 0 | 0.05 |
| superfine) | | | | |
| Minors* | Balance to 100% with water | | | |
| pH | 9 | 9 | 6 | 6 |
| | Ex. 5 | Ex. 6 | Ex. 7 | Ex. 8 |
| Linear Alkylbenzene | — | — | 15% | 6% |
| Sulfonate (1) | | | | |
| Alkyl Ethoxy Sulfate (2) | 5% | 30% | 10% | — |
| Paraffin Sulfonate (C15) | 22% | — | — | — |
| CAP = coco amido propyl | 5% | 1.0% | — | — |
| Betaine | | | | |
| Nonionic (3) | 4% | 0.4% | 0.6% | 3% |
| Amine Oxide (4) | — | — | 4% | 1.0% |
| Alkylpolyglucoside | — | — | — | — |
| Alcohol (5) | 3% | — | 4% | — |
| PPG = | — | — | — | 0.5% |
| polypropyleneglycol | | | | |
| Citrate | 0.1% | 0.5% | 0.3% | 0.8% |
| Salt (6) | 0.3% | 0.6% | 0.2% | — |
| SCS = sodium cumene | — | — | 2% | — |
| sulfonate | | | | |
| sorbitol | — | 10% | 8% | — |
| urea | 4% | — | — | 4% |
| cationic polymer (8) | 0.05% | 0.15% | 0.2% | 0.25% |
| Purafect Prime ® ex | 15 | 35 | 60 | 100 |
| Genencor (ppm) | | | | |
| Glycol distearate from | 0.5 | 0 | 0.3 | 0 |
| Euperlan ® Cognis | | | | |
| Hydrogenated Castor Oil | 0 | 0.15 | 0 | 0.2 |
| Thixcin ® Elementis | | | | |
| Mica (BASF Mearlin | 0 | 0.1 | 0 | 0.05 |
| superfine) | | | | |
| Minors* | Balance to 100% with water | | | |
| pH | 7 | 5.5 | 7 | 6 |
| | Ex. 9 | Ex. 10 | Ex. 11 | Ex. 12 |
| Linear Alkylbenzene | 16% | — | — | — |
| Sulfonate (1) | | | | |
| Alkyl Ethoxy Sulfate (2) | 4% | 9% | 20% | 6% |
| Paraffin Sulfonate (C15) | — | 14% | 3% | 9% |
| CAP = coco amido propyl | — | 0.7% | 2% | 1% |
| Betaine | | | | |
| Nonionic (3) | 2% | 2.5% | 2% | 0.5% |
| Amine Oxide (4) | 0.5% | 2.5% | 2% | 2% |
| Alkylpolyglucoside | — | — | — | — |
| Alcohol (5) | 3% | — | 2% | 3% |
| PPG = | 0.5% | — | 1% | — |
| polypropyleneglycol | | | | |
| Citrate | 0.6% | 0.5% | 1.5% | — |
| Salt (6) | 0.5% | 0.5% | — | 1% |
| SCS = sodium cumene | — | — | — | — |
| sulfonate | | | | |
| glycerol | 7% | 1% | 2% | 5% |
| sorbitol | — | 3% | 4% | |
| cationic polymer (9) | 0.1% | 0.15% | 0.2% | 0.05% |
| Purafect Prime ® ex | 40 | 65 | 80 | 100 |
| Genencor (ppm) | | | | |
| Glycol distearate from | 0.6 | 0 | 0.5 | 0 |
| Euperlan ® Cognis | | | | |
| Hydrogenated Castor Oil | 0 | 0.05 | 0 | 0.25 |
| Thixcin ® Elementis | | | | |
| Mica (BASF Mearlin | 0 | 0.025 | 0 | 0.2 |
| superfine) | | | | |
| Minors* | Balance to 100% with water | | | |
| pH | 5 | 8 | 7.5 | 7.7 |

Minors*: dyes, opacifier, perfumes, preservatives, hydrotropes, processing aids, stabilizers. . .
(1) Linear Alkylbenzene Sulfonate: LAS: C11.4
(2) Alkyl Ethoxy Sulfate: AE×S:
(3) Nonionic: AlkylEthoxylate
(4) Di-methyl coco alkyl amine oxide
(5) Alcohol: Ethanol
(6) Salt: NaCl
(7) cationically modified hydroxyethyl cellulose (Polyquaternium-10 - UCARE LR-400 ex Amerchol).
(8) Guar hydroxypropyl trimmonium chloride (JAGUAR C-17 (Rhodia) - N-Hance 3000 (Hercules-Aqualon)
(9) “Gafquat 755N” (a copolymer of 1-vinyl-2-pyrrolidone and dimethylaminoethyl methacrylate - CTFA name: Polyquaternium-11, product ex ISP),

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing detergent composition comprising at least one humectant and at least one protease.

2. A composition according to claim 1 wherein said humectant is selected from the group consisting of polyethyleneglycol, hexylene glycol, (di)-propylene glycol, glyceryl triacetate, polyalkyleneglycols, phospholipids, collagen, elastin, lecithin, polyethylene glycol ether of methyl glucose, hyaluronic acid, chitosan, pyrrolidone carboxylic acid and its salts, pidolic acid and salts thereof, ceramides, polyols, xylitol and/or maltitol, polymeric polyols, natural extracts, lactic acid and/or urea, alkyl polyglycosides, polybetaine polysiloxanes, lithium chloride and mixtures thereof.

3. A liquid hand dishwashing detergent composition according to claims 1 wherein said protease is a serine protease.

4. A composition according to claim 3 wherein the protease is a subtilisin derived from Bacillus lentus, Bacillus licheniformis, Bacillus alkalophilus, Bacillus subtilis, Bacillus amyloliquefaciens, Bacillus pumilus, Bacillus gibsonii, or Bacillus Cellumonas and/or mixtures thereof.

5. A composition according to claim 1 wherein said composition further comprises about 4% to about 40% by weight of an anionic surfactant and comprising no more than about 15% by weight of the total composition, of a sulfonate surfactant.

6. A composition according to claim 5 wherein the anionic surfactant level is comprised at a level of from about 6% to about 32%.

7. A composition according to claim 6 wherein the anionic surfactant system comprises no more than about 10% by weight of the total composition of sulfonate surfactant.

8. A composition according to claim 5 comprising a combined ethoxylation degree less than 5.

9. A composition according to claim 1 further comprising about 0.01% to about 20% by weight of a surfactant selected from the group consisting of an amphoteric surfactant, a zwitterionic surfactant, and mixtures thereof.

10. A composition according to claim 9 wherein the surfactant is selected from the group consisting of amine oxide and betaines surfactants.

11. A composition according to claim 1 further comprising from about 0.1% to about 20% by weight of the liquid detergent composition of a nonionic surfactant selected from the group consisting of C₈-C₂₂ aliphatic alcohols with 1 to 25 moles of ethylene oxide, alkylpolyglycosides, fatty acid amide surfactants, and mixtures thereof.

12. A liquid hand dishwashing detergent composition according to claim 1 wherein said composition further comprises about 4-40% by weight of an anionic surfactant, wherein said anionic surfactant is an alkyl sulfate or alkyl ethoxy sulfate, and no more than about 10% by weight linear alkylbenzene sulfonate.

13. A liquid hand dishwashing detergent composition according to claim 1 wherein said composition further comprises a cationic polymer.

14. A composition according to claim 13 wherein the cationic polymer is a cationic cellulose polymer or cationic guar gum derivative.

15. A composition according to claim 14 wherein the cationic polymer is a salt of hydroxyethyl cellulose reacted with trimethyl ammonium substituted epoxide.

16. A liquid hand dishwashing detergent composition according to claim 1 wherein said composition further comprises a rheology modifier.

17. A liquid hand dishwashing detergent composition according to claim 1 wherein said composition further comprises a pearlescent agent.
